(19) United States
(12) Patent Application Publication
(10) Pub. No.: US 2014/0270324 A1
(43) Pub. Date: Sep. 18, 2014

(54) MODULAR SPEAKER SYSTEM

(71) Applicant: RedSonic Sound, Inc., Stamford, CT (US)

(72) Inventors: Jonathan REDMOND, Stamford, CT (US); Lyndel L. WILLIAMS, New York, NY (US)

(73) Assignee: RedSonic Sound, Inc., Stamford, CT (US)

(21) Appl. No.: 14/211,044

(22) Filed: Mar. 14, 2014

Related U.S. Application Data
(60) Provisional application No. 61/790,509, filed on Mar. 15, 2013.

(51) Int. Cl. H04R 1/02

(52) U.S. Cl. CPC H04R 1/02
USPC 381/395

(57) ABSTRACT

A speaker unit including a housing, a connector adapted to form a physical connection with a cooperating connector of a second speaker unit in order to physically join the speaker unit to the second speaker unit, and an input port adapted to form an electrical connection to an input source. The speaker unit may further include an electrical coupling that is automatically engaged with an electrical coupling of a second speaker unit when the connectors are fully engaged. A speaker unit may include a cover for providing and/or adjusting an opening at the back of a speaker unit.

### PRIORITY APPLICATION

This application claims the benefit of U.S. provisional application Ser. No. 61/790,509 filed March 15, 2013, which is incorporated herein by reference in its entirety.

### BACKGROUND OF THE INVENTION

1. Field of the Invention

The present invention relates to electronic sound systems and, more particularly, to a modular speaker system.

2. Discussion of the Related Art

Musicians and concertgoers alike have become accustomed to a specific type of amplifier and speaker cabinet combination that produces powerful sound as well as controlled distortion of tones derived from electric guitars, basses, and other electronically amplified musical instruments.

Now common across the music industry, these amplifier and speaker systems were used by legendary bands such as the Rolling Stones, the Kinks, the Who, the Beatles, the Yardbirds, and the Byrds. Other artists, such as Jimi Hendrix, Eric Clapton, the Doors, AC/DC, Metallica, Sonic Youth, and many others, followed suit.

Probably the most renowned and proficient designer of such amplifier and speaker systems was Dr. Jim Marshall, OBE (1923-2012). Also known as the “Father of Loud,” Marshall was awarded the prestigious “Induction into The Rock and Roll Hall of Fame” in 2012. The “Marshall Stack” has become recognized by the music industry as the term identifying the unique setup which usually consists of at least two large speaker cabinets, one stacked on top of the other, with the amplifier “head” then stacked on top of the two cabinets.

Although numerous speaker configurations have been developed, Marshall remains the standard of the industry. A top quality Marshall Stack can cost upwards of $5,000 and weigh in excess of 200 lbs. To reduce cost and weight, some musicians use a “half stack” configuration. In a half stack configuration, only one speaker cabinet is used with the amplifier head stacked on top. Transporting a half stack remains challenging as just a single cabinet often cannot fit into a car trunk. In addition, even a secondhand half stack can cost over $1,000.

Speaker systems for musical instruments can include one or more speakers mounted in a heavy cabinet. Typically, cabinets are available with one, two, or four main speakers of the same dimensions. Additional speakers can be added stacking two or more cabinets together and connecting them to one another with flexible electrical cables. The speaker cabinets can also be connected to an external amplifier with another cable or set of cables. Despite advances in the art, hook up cables remain a constant source of problems. The short life span and frequent repair or replacement of electrical cables continues to cause short circuits and open connections that can result in amplifier damage.

The cabinets themselves are often constructed from thick solid wood or plywood. In addition, the magnets within each speaker can weigh up to 20 lbs. Accordingly, a speaker cabinet including a combination of heavy wood construction and multiple 20 lb magnets can be quite heavy. Moreover, some musicians have been known to stack an entire wall of these speaker cabinets upon one another, utilizing, for example, 40 or more 4 ft.×4 ft. square speaker cabinets in stacks four cabinets high.

In light of the drawbacks of existing speaker systems, the inventors have identified a need for an alternative to the heavy, cumbersome, and expensive speaker cabinets that most musicians performing live currently use. To this end, a modular speaker system is proposed.

### SUMMARY OF THE INVENTION

The present invention is directed to a modular speaker system that substantially addresses or obviates one or more limitations or disadvantages of the related art.

Features and advantages of the invention are set forth in the description which follows, or will be apparent from the description, or may be learned by practice of the invention.

In one example, a modular speaker system includes a speaker unit including a housing, a connector adapted to form a physical connection with a cooperating connector of a second speaker unit in order to physically join the speaker unit to the second speaker unit, and an input port adapted to form an electrical connection to an input source. The connector may be any suitable connector such as, for example, track, latch, and/or plug connectors.

The speaker unit may further include an electrical coupling adapted to form an electrical connection with a cooperating electrical coupling of the second speaker unit in order to electrically couple the speaker unit to the second speaker unit. The electrical coupling may be arranged so that fully engaging the connector with the cooperating connector of the second speaker unit to physically join the speaker unit to the second speaker unit results in correspondingly engaging the electrical coupling with the cooperating electrical coupling of the second speaker unit to electrically couple the speaker unit to the second speaker unit.

The modular speaker system may include a plurality of speaker units, wherein speaker units are arranged into one or more speaker groups, each speaker group having at least one speaker unit.

In another example, a modular speaker system includes a speaker unit including a housing, a diaphragm disposed at a front side of the speaker unit, and a cover disposed at the rear side of the speaker unit, wherein the cover is adapted to be at least one of removed or adjusted to provide an opening at the rear side of the speaker unit.

In another example, a modular speaker system includes a speaker unit including a housing and an interlocking mechanism at front and rear sides of the speaker unit adapted to form a physical connection between the speaker unit and at least a second speaker unit.

It is to be understood that both the foregoing general description and the following detailed description are exemplary and explanatory and are not intended to limit the invention to the described examples.

### BRIEF DESCRIPTION OF THE DRAWINGS

FIG. 1 illustrates a speaker system arranged in an example configuration.

FIG. 2A illustrates a speaker unit having a removable cover unit.

FIGS. 2B and 2C illustrate speaker units having an adjustable cover unit.

FIG. 3 illustrates a speaker unit having an interlocking mechanism.

FIG. 4 illustrates a track connector for connecting speaker units.

FIG. 5 illustrates an electrical coupling within a track connector.

FIG. 6 illustrates a schematic diagram of an example of connecting speaker units together with switches for connecting them in parallel and/or in series.

FIG. 7A shows a schematic diagram of an example of a circuit within a speaker unit, allowing connection in parallel and/or in series.

FIG. 7B shows the diagram of FIG. 7A switched in parallel mode.

FIG. 7C shows the diagram of FIG. 7A switched in series mode.

FIG. 8 shows an example of connecting several speaker units together.

FIGS. 9A-9E illustrate example alternative cross-sectional shapes for speaker units.

FIG. 10 illustrates a speaker mounting unit arranged in an example configuration.

### DETAILED DESCRIPTION OF THE INVENTION

FIG. 1 illustrates a speaker system 100 arranged in an example configuration. As shown in FIG. 1, the speaker system 100 includes an amplifier 110 and a plurality of speaker groups GR1, GR2, and GR3, each speaker group including one or more speaker units 120. Example speaker unit 120 includes a housing 125, one or more first connectors 131, one or more second connectors 141, electrical input port 151, and electrical output port 152. Connector cables 161, 162, and 163 can be used to connect a speaker unit 120 in speaker group GR1 to amplifier 110, to connect speaker group GR1 to speaker group GR2, and to connect speaker group GR2 to speaker group GR3.

A variety of connectors 131 and 141 can be used in order to physically join or connect each speaker unit to an adjacent speaker unit 120, enabling the connection of multiple speaker units 120. As would be understood by a person of ordinary skill in the art, in the context of this description, a connector “physically” connects or forms a “physical” connection between two units when those two units are rigidly interlocked. When two speaker units are physically connected, they are connected together such that they only can be moved together. By contrast, two separate speaker units that are connected only by a flexible cable (such as for an electrical connection) would not be physically connected. Some example connector types for forming a physical connection between speaker units include track, latch, and plug connectors. As will be discussed in connection with FIG. 4, example track connectors may include a tongue-like structure that can be used as male first connector 131 and a groove structure that can be used as female second connector 141.

Speaker units that are physically coupled or connected can be electrically coupled or connected using a variety of electrical connectors (e.g., as shown in FIG. 5). For example, a male electrical coupling may include a plurality of connecting pins, and a corresponding female electrical coupling may include a plurality of connecting sockets. The electrical coupling can be located adjacent to first and second connectors 131 and 141. Alternatively, the electrical coupling can be disposed within first and second connectors 131 and 141.

Multiple speakers 120 can be physically and electrically connected through connectors 131 and 141. The electrical couplings can be arranged so that the engaging of a first connector 131 of a first speaker unit with the cooperating second connector 141 of another speaker unit can result in both the physical and electrical couplings of the speaker units.

When speaker units are not physically coupled, speaker units 120 can be electrically coupled using conventional electrical cables that connect the output port 152 of a first speaker unit to the input port 151 of another speaker unit. In yet another alternative, speaker units can be connected wirelessly using proprietary or standard wireless protocols, such as Bluetooth.

The housing 125 of speaker unit 120 can be formed from various lightweight materials. Example materials include a variety of plastics, preferably durable and lightweight plastics. Lightweight metals, such as aluminum, can also be used. Housing 125 may also include internal chambering for porting bass ducts. Although a circular cylindrical housing is illustrated in FIG. 1, other cross-sectional shapes are also feasible, such as triangular, square, rectangular, hexagonal, and octagonal shapes. Regardless of the material and cross-sectional shape, each of the speaker housings 125 should be strong enough to support the weight of additional speakers as well as an amplifier 110 stacked thereon. FIGS. 9A-9E illustrate some example cross-sectional shapes, including circular (FIG. 9A), rectangular (FIG. 9B), triangular (FIG. 9C), dodecagonal (FIG. 9D), and octagonal (FIG. 9E).

Referring back to FIG. 1, commercially available amplifiers 110 can be coupled to one or more speaker units 120. Alternatively, tiny solid state amplifiers, amplifiers, pre-amplifiers, processors, and/or crossover network circuits can be incorporated within the speaker units 120. In yet another alternative, an amplifier 110 may be adapted with one or more connectors, such as connectors 131 or 141, such that the amplifier 110 may be physically connected to one or more speaker units 120, and such that, if desired, the amplifier 110 may be electrically connected to one or more speaker units, without the use of external cable 161.

Multiple speaker units 120 can be arranged into one or more speaker groups, each speaker group having at least one speaker unit. For example, groups of two or four speaker units 120, such as GR1, GR2, and GR3, can be physically and electrically connected when joined together by male and female connectors 131 and 141. Alternatively, groups of speakers 120 can also be electrically coupled using external electrical cables, such as cables 162 and 163, through input and output ports 151, 152. In some instances, the use of an external cable may be desired even though an alternative, such electrical couplings located within connectors 131 and 141, is available. In such instances, an electrical isolator (e.g., a switch or electrically insulating material) can be used to prevent electrical couplings. For example, use of an external cable may be preferred between speaker groups.

Speaker units 120 or speaker groups, such as GR1-GR3, can operate as a single speaker or a group of two or more speakers. Numerous additional speaker units 120 (e.g., groups of one, two, three, or four speakers) can be coupled to the modular speaker system 100 using connectors 131 and 141 and/or external electrical cables.

A speaker unit 120 may include one or more electrical switches (not shown) to control various functions of the speaker unit. For example, a speaker unit 120 may include a switch to set whether the speaker unit and another speaker unit are electrically connected in series or parallel. In another example, the speaker unit 120 may include a switch to set the speaker impedance to one of a plurality of predetermined values (e.g., 4, 8, or 16 ohms).

FIG. 2A illustrates a speaker unit 220A having a removable cover unit 245A. FIG. 2B illustrates a speaker unit 220B having an example adjustable cover unit 245B. FIG. 2C illustrates a speaker unit 220C having another example adjustable cover unit 245C.

As shown in FIG. 2A, the speaker unit 220A unit includes a housing 225A, a diaphragm unit 235A located at a front side of the housing 225A, and a cover unit 245A located at a rear side of the housing 225A. Similarly, as shown in FIG. 2B, the speaker unit 220B includes a housing 225B, a diaphragm unit 235B located at a front side of the housing 225B, and a cover unit 245B located at a rear side of the housing 225B. Similarly, as shown in FIG. 2C, the speaker unit 220C includes a housing 225C, a diaphragm unit 235C located at a front side of the housing 225C, and a cover unit 245C located at a rear side of the housing 225C.

A cover unit, as in FIGS. 2A, 2B, or 2C, operates to close or partially close the rear side of a speaker unit. By controlling the rear opening of the speaker housing, increased versatility in tone and frequency variation can be achieved. The cover unit 245 can have several different configurations. While conventional speaker cabinets included either an open back or closed back cabinet, cover units as described herein allow selectively opening the back of the speaker unit.

Example removable and/or adjustable cover units are provided. The aperture of the removable cover unit 245 can be fixed (e.g., open, closed, or partially open) or adjustable. In one example, a cover unit 245A that is removable and closes the rear opening of speaker unit 220A is provided. In another example, an adjustable cover unit 245B may include two or more rotating discs 241 and 242, each of the discs having at least one opening. As shown in FIG. 2B, disc 241 has openings 243 and disk 242 has openings 244. The rotation of one disc with respect to the other will result in differing alignments between the openings of the discs. As would be understood by a person of ordinary skill in the art, in the adjustable cover unit 245B, one of the discs 241 or 242 could be stationary or fixed, while the other disc is rotatable relative to it, in order to change the relative alignments of the openings 243, 244. Alternatively, a fixed adjustable cover unit can also be provided.

In yet another example, increased versatility in tone and frequency variation can be achieved by adjusting the distance between the speaker diaphragm 235C and the cover unit 245C. For example, the adjustable cover unit 245C may include a cover portion 251, fixed outer cylinder 252, adjustable inner cylinder 253, and a tuning shaft 254. In the depicted example configuration, the tuning shaft 254 may be coupled to adjustable inner cylinder 253 by a turnable and threaded screw-type shaft 255, such that rotation of the tuning shaft 254 adjusts the distance of the inner cylinder 253 from the speaker diaphragm 235C. Other mechanisms, such as sliding, ratcheting, and telescoping mechanisms, may be used to adjust the position of adjustable inner cylinder 253 relative to the speaker diaphragm 235C.

Components of the various cover units 245, including rotating discs 241 and 242, cover portion 251, fixed outer cylinder 252, adjustable inner cylinder 253, and tuning shaft 254, may be composed of a variety of plastics, preferably durable and lightweight plastics. Lightweight metals, such as aluminum, can also be used. In addition, the cover portion 251 may have a planar or a curved conical structure.

Thus, adjustable cover units, detachable cover units, and detachable and adjustable covers are provided. By contrast to conventional speaker cabinets in which the back of the speaker cabinet is fixed, the removable and/or adjustable cover unit provides additional versatility in tone and frequency variation.

FIG. 3 illustrates a speaker unit having an interlocking mechanism. As shown in FIG. 3, the example speaker unit 320 includes a housing 325, a diaphragm unit 335 located at a front side of the housing 325 as well as first and second connectors 345 and 355 at front and rear sides of the speaker unit 320.

The first and second connectors 345 and 355 cooperate with corresponding connectors on other speaker units to form an interlocking mechanism that can be employed to form a physical connection between the speaker unit 320 and one or more other speaker units. For example, the first and second connectors 345 and 355 can enable the speaker unit 320 and adjacent speaker units to screw together. In another example, the first and second connectors 345 and 355 can enable the speaker unit 320 and adjacent speaker units to snap or plug together.

When looking at the side view in which multiple speaker units 320 are shown in a back to front configuration, it should be noted that this configuration provides for easy transport of the speaker units 320. In some instances, multiple speaker units may be transported using carrying strap 385. Alternatively, the multiple speaker units may be placed within a padded duffle bag (not shown) that may be incrementally sized to accommodate one or more speaker units 320. The duffle bag may also include a carrying strap. In the duffle bag example, first and second connectors 345 and 355 may not be needed as the duffle bag may be sized to hold multiple speaker units together.

FIG. 4 illustrates speaker units with track connectors. As shown in FIG. 4, an example speaker unit 420 includes a housing 425, a diaphragm unit 435 located at a front side of the housing 425, male first track connector 431, and female second track connector 441. As would be understood by a person of ordinary skill in the art, one speaker unit 420 can be physically connected to an adjacent speaker unit 420 by aligning an end of a male or female track connector of the first speaker unit with the end of an opposite (female or male) track connector of the second speaker unit and sliding the first speaker unit into interlocking engagement with the second speaker unit.

Speaker units that are physically coupled can be electrically coupled using a variety of electrical connectors (e.g., as shown in FIG. 5). For example, a male electrical coupling may include a plurality of connecting pins and a corresponding female electrical coupling may include a plurality of connecting sockets. The electrical coupling can be located adjacent to first and second connectors 431 and 441. Alternatively, the electrical coupling can be disposed within first and second connectors 431 and 441.

Although four track connectors are shown in example speaker unit 420, alternative configurations are feasible. For example, a modular speaker with a triangular cross-section may have three track connectors. Alternatively, a modular speaker with a hexagonal cross-section may have six track connectors. The tracks themselves can be mounted or molded onto the housing 420.

FIG. 5 illustrates an electrical coupling within a track connector according to an example embodiment. As shown in FIG. 5, the example speaker unit 520 includes a housing 525, male first track connector 531, female second track connector 541, male connecting pins 561, and female connecting sockets 571.

In this example, the electrical connectors 561 and 571 automatically make contact whenever two speaker units 520 are physically joined by the interlocking track connectors 531 and 541. Although male connecting pins 561 and female connecting sockets 571 are depicted with three conductive paths, other configurations having one or more conductive paths are feasible. For example, a single pin having one or more conductive paths may be used.

FIG. 6 illustrates a schematic diagram of an example of connecting speaker units together with switches for connecting them in parallel and/or in series. FIG. 6 shows four speakers, represented as resistors 610, 620, 630 and 640. To connect the speakers in parallel, switches P11, P12, P21, P22, P31, P32, P41 and P42 are closed, while switches S13, S23, S33 and S43 are open. To connect the speakers in series, switches S13, S23, S33 and S43 are closed, while switches P11, P12, P21, P22, P31, P32, P41 and P42 are open. It will be appreciated that in the parallel connection, the speakers may be connected to an amplifier by wires at A and B, whereas in the series connection, the speakers may be connected to an amplifier by wires at A and C.

FIG. 7A shows a schematic diagram of an example circuit within a speaker unit, allowing connection in parallel and/or in series. FIG. 7A shows a single speaker unit, represented as resistor 710. To connect speakers in parallel, switches P71 and P72 are closed, while switch S73 is open. This parallel mode is shown in FIG. 7B. To connect speakers in series, switch S73 is closed, while switches P71 and P72 are open. This series mode is shown in FIG. 7C. It will be appreciated that several identical speaker units can be connected together with this arrangement.

FIG. 8 shows one example of connecting several speaker units together, with switching ability to connect the speaker units in parallel and/or in series. In some instances, speaker units may be connected in series or in parallel, and in other instances speaker units may be connected using a combination of series and parallel connections. As shown in FIG. 8, each of a plurality of speaker units 810 in speaker group GR8 may be connected in parallel and/or in series. Each speaker unit is represented as a resistor. To connect speakers in parallel, switches P81 and P82 are closed, while switch S83 is open. To connect speakers in series, switch S83 is closed, while switches P81 and P82 are open. It will be appreciated that several identical speaker units can be connected together with this arrangement.

FIGS. 9A-9E illustrate example alternative cross-sectional shapes for the speaker units. Some example cross-sectional shapes include circular (FIG. 9A), rectangular (FIG. 9B), triangular (FIG. 9C), dodecagonal (FIG. 9D), and octagonal (FIG. 9E).

Irrespective of a speaker's cross-sectional shape, each speaker unit may include a plurality of connectors 931 (e.g., male track connectors 931A, 931B, 931C, 931D, and 931E) and 941 (e.g., female track connectors 941A, 941B, 941C, 941D, and 941E) in order to physically join each speaker unit to an adjacent speaker unit. Some example connector types for physically connecting speaker units together include track, latch, and plug connectors. As discussed above in connection with FIGS. 4 and 5, example track connectors may include a tongue-like structure that can be used as first connector 931 and a groove structure that can be used as second connector 941.

In addition, speaker units that are physically coupled can be electrically coupled using a variety of electrical connectors (e.g., as shown in FIG. 5). Here, for example, a male electrical coupling may include a plurality of connecting pins, and a corresponding female electrical coupling may include a plurality of connecting sockets. The electrical coupling can be located adjacent to first and second connectors 931 and 941. Alternatively, the electrical coupling can be disposed within first and second connectors 931 and 941.

FIG. 10 illustrates a speaker mounting unit arranged in an example configuration. As shown in FIG. 10, the speaker mounting unit 1000 supports multiple speaker units 1020 using mounting track connecters 1071 and 1081.

Example speaker unit 1020 includes a housing 1025, one or more first connectors 1031, one or more second connectors 1041, electrical input port 1051, and electrical output port 1052. Although not shown, connector cables can be used to connect speaker units 1020 within mounting unit 1000 to an amplifier and/or other speakers.

A variety of connectors 1031 (e.g., male connectors) and 1041 (e.g., female connectors) can be used in order to physically join each speaker unit to an adjacent speaker unit, enabling the connection of multiple speaker units 1020. Mounting track connectors 1071 and 1081 are the same as connectors 1031 and 1041, respectively, but are provided on speaker mounting unit 1000 instead of speaker units 1020. Thus, mounting connectors 1071 (e.g., male connector) and 1081 (e.g., female connector) can be used in order to physically join each speaker unit to the speaker mounting unit 1000. For example, mounting connectors 1071 and 1081 may be mounted along the inner perimeter of a tubular mounting structure of mounting unit 1000. Some example connector types include track, latch, and plug connectors.

With the above examples and other embodiments within the scope of the claims, a modular speaker system that is both lightweight and inexpensive is provided. The modular speaker system reproduces the very recognizable and desirable tones of a Marshall Stack, but does so at a fraction of the cost, weight, and bulk of the current systems.

With the modular speaker system, a rising musician can purchase one or two individual speakers at a reasonable cost. In addition, because the speaker system is modular, additional speakers can be added over time. With more versatile speakers in hand, the struggling musician can begin to book “gigs” at a wide array of venues.

The modular speaker system need not be limited to musicians, but can be applicable to any electronic sound or audio systems and equipment. It will be apparent to those skilled in the art that various modifications and variations can be made in the modular speaker system of the present invention without departing from the spirit or scope of the invention. Thus, it is intended that the present invention cover the modifications and variations of this invention provided they come within the scope of the appended claims and their equivalents.

What is claimed is:

1. A speaker unit comprising:
a housing;
a connector adapted to form a physical connection with a cooperating connector of a second speaker unit in order to physically join the speaker unit to the second speaker unit; and
an input port adapted to form an electrical connection to an input source.

2. The speaker unit according to claim 1, wherein the connector is a track connector.

3. The speaker unit according to claim 1, wherein the connector is a latch connector.

4. The speaker unit according to claim 1, wherein the connector is a plug connector.

5. The speaker unit according to claim 1, further comprising an electrical coupling adapted to form an electrical connection with a cooperating electrical coupling of the second speaker unit in order to electrically couple the speaker unit to the second speaker unit.

6. The speaker unit according to claim 5, wherein the electrical coupling includes a plurality of connecting pins.

7. The speaker unit according to claim 5, wherein the electrical coupling includes a plurality of connecting sockets.

8. The speaker unit according to claim 5, wherein the electrical coupling is arranged so that fully engaging the connector with the cooperating connector of the second speaker unit to physically join the speaker unit to the second speaker unit results in correspondingly engaging the electrical coupling with the cooperating electrical coupling of the second speaker unit to electrically couple the speaker unit to the second speaker unit.

9. The speaker unit according to claim 1, wherein the housing is cylindrical.

10. The speaker unit according to claim 1, wherein the housing is made of molded plastic.

11. The speaker unit according to claim 1, further comprising a switch to set whether the speaker unit and the second speaker unit are electrically connected in series or parallel.

12. The speaker unit according to claim 1, further comprising a switch to set the speaker impedance to one of a plurality of predetermined values.

13. A modular speaker system, comprising:
a plurality of speaker units, each of the speaker units comprising:
a housing,
a connector adapted to form a physical connection with a cooperating connector of a second speaker unit in order to physically join the speaker unit to the second speaker unit, and
an input port adapted to form an electrical connection to an input source;
wherein the speaker units are arranged into one or more speaker groups, each speaker group having at least one speaker unit.

14. The modular speaker system according to claim 13, wherein each of the speaker units further comprises an electrical coupling adapted to form an electrical connection with a cooperating electrical coupling of the second speaker unit in order to electrically couple the speaker unit to the second speaker unit.

15. The modular speaker system according to claim 14, wherein the speaker units are arranged into at least two speaker groups, the speaker groups being connected by electrical couplings that are electrically insulated.

16. The modular speaker system according to claim 13, wherein a first speaker group is electrically connected to a second speaker group by an external cable.

17. A speaker unit comprising:
a housing;
a diaphragm disposed at a front side of the speaker unit; and
a cover disposed at the rear side of the speaker unit, wherein the cover is adapted to be at least one of removed or adjusted to provide an opening at the rear side of the speaker unit.

18. The speaker unit according to claim 17, wherein the cover has an adjustable aperture.

19. The speaker unit according to claim 17, wherein the cover comprises two or more discs, each of the discs having at least one opening, such that the rotation of one disc with respect to another disc will result in differing alignments between the openings of the discs.

20. A speaker unit comprising:
a housing; and
an interlocking mechanism at front and rear sides of the speaker unit adapted to form a physical connection between the speaker unit and at least a second speaker unit.
